(19) United States
(12) Patent Application Publication
(10) Pub. No.: US 2013/0160082 A1
(43) Pub. Date: Jun. 20, 2013

(54) Medical Device Connectivity to Hospital Information Systems Using Device Server

(71) Applicant: Daryl R. Miller, Rancho Santa Margarita, CA (US)

(72) Inventor: Daryl R. Miller, Rancho Santa Margarita, CA (US)

(73) Assignee: LANTRONIX, INC., Irvine, CA (US)

(21) Appl. No.: 13/816,309

(22) PCT Filed: Aug. 31, 2011
(86) PCT No.: PCT/US11/50060

§ 371 Date: Feb. 11, 2013

Related U.S. Application Data
(60) Provisional application No. 61/378,767, filed on Aug. 31, 2010.

(51) Int. Cl. H04L 29/08

(52) U.S. Cl. CPC H04L 67/14; H04L 63/08
USPC 726/3; 709/227

(57) ABSTRACT

The present invention employs a system and method to allow for connectivity of a plurality of medical devices in a health care setting. The present invention utilizes a device server which may connect the plurality of medical devices to a hospital information system. The system may identify and authenticate a medical device and provide an administrator or privileged user accessing the information received from the medical device at a remote location. It is contemplated that the system utilizes a device server to connect the plurality of medical devices to the hospital information systems.

### PRIORITY CLAIM

This application claims priority to the earlier filed U.S. Provisional Application No. 61/378,767 filed on Aug. 31, 2010, entitled “Medical Device Connectivity to Hospital Information Systems Using Device Server” which is incorporated by reference.

### FIELD OF THE INVENTION

The present invention relates to medical device connectivity and more particularly, to connection of a plurality of medical devices in a health care facility to a hospital information system by utilizing a device server.

### BACKGROUND

The number of network-connected devices has grown dramatically over the last decade. Such growth is expected to continue far into the future, causing enormous problems of integration for consumers, companies, and governments. One significant problem is the inclusion of many legacy devices that were never intended to be connected to a network. For instance, a legacy medical device which monitors a patient's glucose level can now be accessed remotely by medical personnel eliminating the need for someone to be physically at the device to take the reading. The equipment status can also be monitored and preventative repairs done before hard failures occur. Many medical devices are still designed without networking in mind. Another problem is the ever-growing number of network enabled devices that have inadequate monitoring and control capabilities. These problems are pervasive, involving all manners of equipment from fax machines, printers, copiers and other office equipment, to specialized devices found in manufacturing plants, home appliances, and hand-held electronics such as cameras, audio/video players and medical devices that have network capability but are not part of an integrated network. This problem is particularly acute for the administrators, who often find themselves spending a great deal of money and time bridging heterogeneous management systems. Most of these devices do not contain state information and are even more difficult to manage. A more homogeneous management environment can save time and money, but numerous vendors have many valid business and technical reasons for avoiding homogeneous management systems.

Device management functionality comes in many different forms depending on the administrator's needs and the capabilities of the target device. Common management functions include monitoring the device's critical information, taking an inventory of the devices sub-systems, logging interesting events that take place, sending alerts to an administrator, recovering the device if the power fails, ensuring the data is secure, asset tracking, or reporting information to an administrator. Administrators also employ more advanced management functions including scripting or programming, aggregating device data from multiple devices, diagnostics, taking action based on the device data content, trending device data, reporting information in a final format including a spreadsheet or graph, or translating from one management format to another. A major area of management functionality includes securing the device through providing confidentiality of data, data integrity, administrator authentication, device authentication, risk mitigation, countermeasures, or protection against hostile environments and threats.

As an example, various medical devices surrounding a patient's bed operate independently of each other and include non-standard wires, tubes, and interfaces. One problem is lack of integration between the medical devices. For example, some medical devices generate information in a proprietary format, which is not compatible with other medical devices from different vendors. In another example, a medical device may produce an analog signal for a patient's vital signs; because the signal is not digital or recorded, the analog signal must be transcribed onto a piece of paper or else the information is lost. As a result of this lack of integration, health care professionals must pay greater attention to control and monitor many medical devices individually, requiring more personnel to transcribe the data, more time to review the data, and greater potential for lost data and transcription error. Some devices with analog signals may store the data for short periods of time but again, the time must be taken later to review and transcribe the information. Additionally, there is little to no integration between the plurality of medical devices.

However, a need exists for a system and method for remotely connecting a plurality of medical devices inside a health care facility. Moreover, a need exists for a system and reliable method for connecting a plurality of medical devices to a hospital information system by utilizing a device server to identify, authenticate and securely transfer data from the medical device to the hospital information system.

### SUMMARY OF THE INVENTION

The present invention employs a system and method to allow for connectivity of a plurality of medical devices in a health care setting. The present invention utilizes a device server which may connect the plurality of medical devices to a hospital information system. The system may identify and authenticate a medical device and provide an administrator or privileged user accessing the information received from the medical device at a remote location. It may utilize an external adaptor to uniquely identify the attached equipment. It is contemplated that the system utilizes a device server to connect the plurality of medical devices to the hospital information systems. It is also contemplated that appropriate device drivers may be loaded such that the device server can appropriately communicate with the attached device.

An exemplary embodiment of the present invention is to provide a system for integrating and connecting medical devices into a medical facility network, comprising: a terminal interfacing with the medical facility network; a display in communication with the terminal; a medical device within wireless range of the medical facility network; and wherein the medical facility network is configured to transmit an initialization signal to the medical device and is configured to automatically initialize in response to receiving the initialization signal.

In an exemplary embodiment, a system for integrating and connecting medical devices into a medical facility network, comprising: a device server/terminal interfacing with the medical facility network; a medical device which is attached to the device server either wired or wirelessly; and wherein the medical facility network is configured to transmit an initialization signal to the medical device and is configured to automatically initialize in response to receiving the initialization signal.

In an exemplary embodiment, wherein a display is in communication with the device server to show status and other information.

In an exemplary embodiment, wherein the medical device is automatically detected by the medical facility network upon introduction into the medical treatment area.

In an exemplary embodiment, wherein initializing comprises of powering the medical device into an active power state.

In an exemplary embodiment, wherein the medical facility network is connected to the Internet, thereby facilitating data exchange between the medical facility network and another entity.

In an exemplary embodiment, wherein the wireless range is limited to approximately the medical treatment area.

In an exemplary embodiment, wherein the medical facility network comprises of a local network or facility wide network.

In an exemplary embodiment, wherein the system is further configured to remotely monitor and diagnose remote medical devices once the medical device has been located and analyzed by the hospital information systems.

In an exemplary embodiment, further comprising a conduit manager to create a direct communication tunnel to a medical device.

In an exemplary embodiment, wherein the device server/terminal comprises a first device server that resides in a first local network and a second device server that resides in a second local network distinct from the first local network.

In an exemplary embodiment, further comprising a device serve that resides in a wide area network external to both the first and second device servers.

In an exemplary embodiment, wherein both the first and second device servers create their own direct communication tunnel to the device manager by periodically authenticating themselves to the device manager and establishing an outgoing TCP/IP stream connection to the device manager and then keeps that connection open for future bi-directional communication on the outgoing TCP/IP stream connection and wherein the device servers communicates with both the medical devices and the medical facility network.

In an exemplary embodiment, wherein the device server initiates a connection the device manager which will manage the connection between the host and the medical device.

In an exemplary embodiment, further configured to target the medical device whereby the system may be notified when the targeted medical device is malfunctioning.

In an exemplary embodiment, wherein the device server is further configured to provide information from the medical device to a system administrator through which error messages, device data and other information may be sent remotely to the administrator for analysis and review.

In an exemplary embodiment, a method to allow for connectivity of a medical device in a health care setting comprising: detecting and locating the medical device in the medical treatment area by the medical facility network; identifying a medical device and authenticating the medical device and providing an administrator or privileged user access to the information received from the medical device at a remote location; initializing the medical device; and connecting and monitoring the medical devices.

In an exemplary embodiment, further comprising of using a device server to communicate, monitor and connect the medical devices with an administrator and/or hospital information system.

In an exemplary embodiment, further comprising of using an external adaptor to uniquely identify any attached equipment.

In an exemplary embodiment, further comprising of automatically detecting the medical device upon introduction of the medical device into the medical treatment area.

In an exemplary embodiment, further comprising of powering the medical device into an active power state to cause initialization of the device.

In an exemplary embodiment, wherein the medical device is automatically detected by the medical facility network upon introduction into the medical treatment area.

In an exemplary embodiment, wherein initializing comprises of powering the medical device into an active power state.

In an exemplary embodiment, wherein the medical facility network is connected to the Internet, thereby facilitating data exchange between the medical facility network and another entity.

In an exemplary embodiment, wherein the wireless range is limited to approximately the medical treatment area.

In an exemplary embodiment, wherein the medical facility network comprises of a local network or facility wide network.

In an exemplary embodiment, it is contemplated that the system may provide access to any number of medical devices in a health care facility. A Device Services Manager (DSM) and a Device Services Controllers (DSCs) forms at least part of the system for identifying and connecting the medical device in a health care facility with a hospital's information system.

As part of the system, and acting as a publicly accessible Virtual Device Network router (VDN router), the DSM manages DSCs units on the Local Area Network (LAN) at each location. The DSM and its DSCs join equipment across the Internet to create a “Virtual Device Network” (VDN). The combined components enable the VDN administrator to discover medical devices located within the facility and allows an administrator to set up and manage individual Virtual IP (VIP) addresses and routes to allow access to each of the individual medical devices located within a desired facility.

Thus, secure access and management of medical equipment, devices and connectivity of these medical devices in a network protected by a firewall from outside networks may be achieved while maintaining a hospital's information system policy along with the integrity of patient information and the customer's hospital information system network firewall.

In an exemplary embodiment, the present invention relates to connecting a plurality of medical devices to a hospital information system.

In still another exemplary embodiment, the present invention allows for remote monitoring and diagnostics of remote medical devices once the medical device has been located and analyzed by the hospital information systems.

Still another exemplary embodiment is to provide a system and method for connecting a plurality of medical devices to a hospital information system whereby the device server may connect to any plurality of medical devices located within any health care facility and/or outside health care facility.

In an exemplary embodiment, a system and method for connecting a plurality of medical devices to hospital information system is provided whereby the system may communicate with the plurality of medical devices by utilizing a wireless network, Ethernet and the like.

Still another exemplary embodiment is to provide a system and method for remotely connecting and monitoring medical devices using a device server to communicate, monitor and connect the medical devices with an administrator and/or hospital information system.

In yet another exemplary embodiment, a system and method to connect a plurality of medical devices to a hospital information system is provided whereby the system is able to detect and locate a medical device in the medical treatment area by the medical facility network, and initialize with the medical device. It is contemplated that after initialization, the system may remotely network with the medical device such that an administrator may be able to connect the medical device and information received from the device with the hospital's information system or allow for use of information received from the device for administrative purposes.

Yet another exemplary embodiment is to provide a system and method to connect a plurality of medical devices into a hospital information system whereby the system detects and locates a medical device in the health care facility, initializes with the medical device and after initialization may remotely network with the medical device such that an administrator may be able to transmit and receive information from the medical device located remotely from the hospital information system and/or administrator with access to the medical device.

Still another exemplary embodiment is to provide a system and method to connect a plurality of medical devices to a hospital information system whereby the system may have a conduit manager to create a direct communication tunnel to a medical device.

Further in an exemplary embodiment, a system and method to remotely monitor and diagnose a medical device is provided whereby the system may have a first device server that resides in a first local network and the second device server resides in a second local network distinct from the first local network.

It is contemplated that the system has a device server manager that resides in a wide area network external to both the first and second device servers. Both the first and second device servers create their own direct communication tunnel to the device manager by periodically authenticating themselves to the device manager and establishing an outgoing TCP/IP stream connection to the device manager and then keeps that connection open for future bi-directional communication on the outgoing TCP/IP stream connection. The device servers communicate with both the medical devices and the hospital information systems.

In still another exemplary embodiment, a system and method to connect a medical device with a hospital information system whereby the system may allow a user and/or administrator located at a host console to open a connection to a designated port on a device server which establishes a connection through to the target medical device. This local device server will then initiate a connection to the controlling device manager which will manage the connection between the host and the medical device.

It is contemplated that the system and method to remotely monitor and diagnose a medical device is provided whereby the system may allow an administrator to receive a incoming connection from the medical device through which the communication may include both stream traffic (e.g. TCP/IP) and packet traffic (e.g. UDP) oriented network connections. The TCP packet header information in general identifies both the source port originally sending the data and the target destination port receiving the packet.

In yet another exemplary embodiment, a system and method for connecting a medical device to a hospital information system is provided whereby the system may allow for targeting a remote medical device whereby the system may be notified when a targeted medical device is malfunctioning.

Yet another exemplary embodiment of the present invention is to provide a system and method for connecting a plurality of medical devices to a hospital information system whereby the device server may provide information from the medical device to a system administrator through which error messages, device data and other information may be sent remotely to the administrator for analysis and review.

Additionally, it should be understood that the inventive subject matter may allow for manipulating data within the responses in a manner that provides at least a communication with a medical device which would not normally communicate with the health care facility network.

### BRIEF DESCRIPTION OF THE DRAWINGS

FIG. 1 is a block diagram illustrating an example system that allows for connectivity of a plurality of medical devices in a health care setting.

FIG. 2 is another block diagram illustrating an example embodiment that allows for remote monitoring and diagnostics of remote medical devices once the medical device has been located and analyzed by the hospital information systems.

FIG. 3 is a flowchart illustrating an example method to allow for connectivity of a plurality of medical devices in a health care setting.

FIG. 4 is another block diagram illustrating an exemplary system 400 for integrating and connecting medical devices 402 into a medical facility network 404.

### DETAILED DESCRIPTION OF THE PREFERRED EMBODIMENT

The systems and methods described herein generally relate to medical device connectivity, and more particularly, an embodiment relates to connection of a plurality of medical devices in a health care facility to a hospital information system by utilizing a device server.

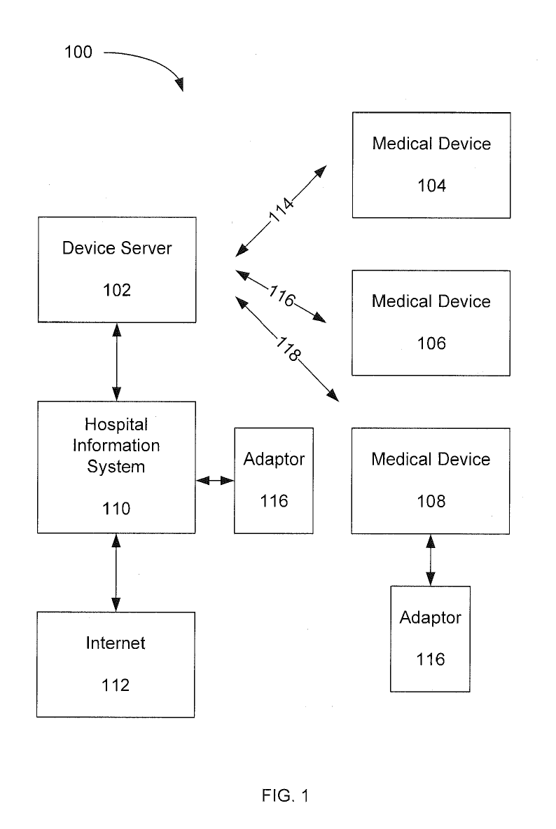

FIG. 1 is a block diagram illustrating an example system 100 that allows for connectivity of a plurality of medical devices 104, 106, 108 in a health care setting. In an example system 100 a device server 102 may connect the plurality of medical devices 104, 106, 108 to a hospital information system 110. In the illustrated example, the system 100 utilizes a device server 102 to connect the plurality of medical devices 104, 106, 108 to the hospital information systems 110. In an exemplary embodiment, appropriate device drivers may be loaded such that the device server 102 can appropriately communicate with the attached device 104, 106, 108.

The system 100 may identify and authenticate a medical device 104, 106, 108 and provide an administrator or privileged user accessing the information received from the medical device 104, 106, 108 at a remote location 112. For example, the system may utilize one or more external adaptors 114, 116 to uniquely identify the attached equipment. The external adaptor may, for example, be attached to the hospital information system, a medical device 108 or both. The adaptor 114 may authenticate unique identifying information from medical device 108. Similarly, adaptor 116 may provide unique identifying information from medical device 108.

The illustrated embodiment also includes a connection between the medical facility network that is connected to the Internet 112, thereby facilitating data exchange between the medical facility network and another entity. In this way the hospital information system 110 may exchange data from medical devices 104, 106, 108 and external sources. For example, updates for the medical devices 104, 106, 108 might be received over the Internet at the hospital information system 110 and transferred to one or more devices 104, 106, 108 through device server 102.

In an exemplary embodiment, a system and method for connecting a plurality of medical devices 104, 106, 108 to hospital information system 110 is provided whereby the system may communicate with the plurality of medical devices 104, 106, 108 by utilizing a wireless network, Ethernet and the like. Accordingly, connections 114, 116, 118, 120 may be a wireless connection, a wired connection, e.g., Ethernet, or a combination of both. In an exemplary embodiment that used a wireless connection, the wireless range might be limited to approximately the medical treatment area.

In the exemplary embodiment system 100 may connect a plurality of medical devices 104, 106, 108 into a hospital information system 110 whereby the system 100 detects and locates a medical device 104, 106, 108 in the health care facility, initializes with the medical device 104, 106, 108 and after initialization may remotely network with the medical device 104, 106, 108 such that an administrator may be able to transmit and receive information from the medical device 104, 106, 108 located remotely from the hospital information system and/or administrator with access to the medical device 104, 106, 108. For example, this may be done by connecting the system 100 to the Internet or other communication network or communication system.

System 100 may connect a plurality of medical devices 104, 106, 108 to a hospital information system 110 whereby the system 100 may have a conduit manager to create a direct communication tunnel to a medical device 104, 106, 108.

Further, the exemplary embodiment illustrated in FIG. 1, the system 100 can remotely monitor and diagnose a medical device 104, 106, 108. For example, the system 100 may have a first device server that resides in a first local network and the second device server that resides in a second local network distinct from the first local network.

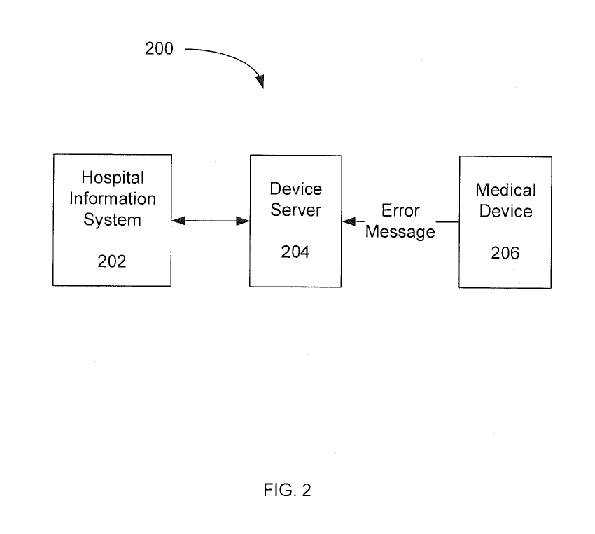

FIG. 2 is another block diagram illustrating an example embodiment that allows for remote monitoring and diagnostics of remote medical devices 206 once the medical device has been located and analyzed by the hospital information systems. An example system 200 connect the medical device 206 to a hospital information system 202 provided whereby the system may allow for targeting a remote medical device 206 whereby the system 200 may be notified when a targeted medical device is malfunctioning 206.

The system may provide connectivity a plurality of medical devices 206 to a hospital information system 202, e.g., through a device server 204 whereby the device server 204 may provide information from the medical device 206 to a system administrator through which error messages, device data and other information may be sent remotely to the administrator for analysis and review.

In the example system the device server 204 may connect to any plurality of medical devices 206 located within any health care facility and/or outside health care facility. Additionally, the example system 200 can provide for remotely connecting and monitoring medical devices 206 using a device server to communicate, monitor and connect the medical devices with an administrator and/or hospital information system.

The system 200 may detect and locate a medical device 206 in the medical treatment area by the medical facility network, and initialize with the medical device. It is contemplated that after initialization, the system may remotely network with the medical device 206 such that an administrator may be able to connect the medical device 206 and information received from the device 206 with the hospital's information system or allow for use of information received from the device for administrative purposes.

The exemplary embodiment of FIG. 2 may cause a medical device 206 to be automatically detected by the medical facility network upon introduction into the medical treatment area. For example, when such a medical device 206 brought to a patient's room to monitor or treat the patient.

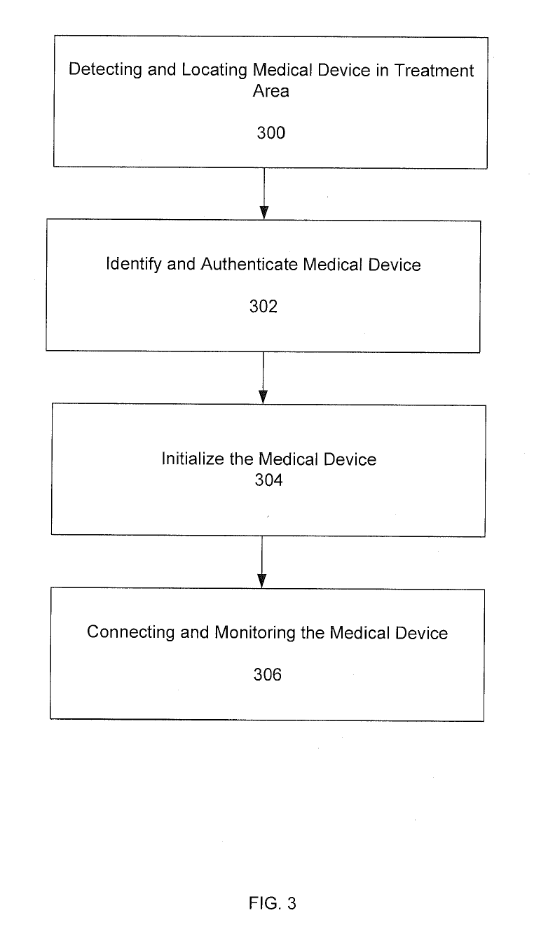

FIG. 3 is a flowchart illustrating an example method to allow for connectivity of a plurality of medical devices in a health care setting. The example method may utilize a device server which may connect the plurality of medical devices to a hospital information system.

In step 300 of the method the system detects and locates a medical device in the medical treatment area by the medical facility network. In step 302 the method identifies a medical device and authenticates the medical device and provide an administrator or privileged user accessing the information received from the medical device at a remote location. In one example identification and authentication may be accomplished by using an external adaptor to uniquely identify the attached equipment. Additionally, in an exemplary embodiment, the medical device is automatically detected by the medical facility network upon introduction into the medical treatment area.

In a step 304 a system implementing the method initializes with the medical device. It is contemplated that after initialization, the system may remotely network with the medical device such that an administrator may be able to connect the medical device and information received from the device with the hospital's information system or allow for use of information received from the device for administrative purposes. In an exemplary embodiment of the method, a medical device that is part of a system implementing the method may be initialized by powering the medical device into an active power state.

In step 304 of the method a system remotely connects and monitors medical devices. For example, a system implementing the method may use a device server to communicate, monitor and connect the medical devices with an administrator and/or hospital information system.

The method may include connecting a plurality of medical devices into a hospital information system whereby the system detects and locates a medical device in the health care facility, initializes with the medical device and after initialization may remotely network with the medical device such that an administrator may be able to transmit and receive information from the medical device located remotely from the hospital information system and/or administrator with access to the medical device. Some embodiments of the method may have a conduit manager to create a direct communication tunnel to a medical device such that a plurality of medical devices can be connected to a hospital information system.

A system implementing the method can initiate a connection to the controlling device manager which will manage the connection between the host and the medical device. For example, this may be performed by a local device server. Additionally, the system may allow a user and/or administrator located at a host console to open a connection to a designated port on a device server which establishes a connection through to the target medical device.

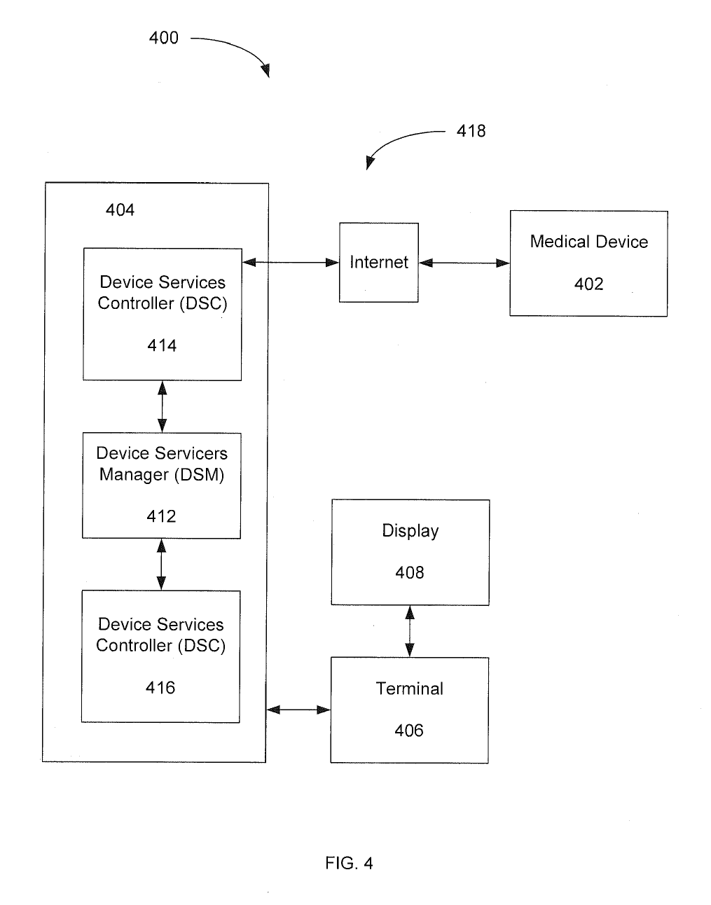

FIG. 4 is another block diagram illustrating an exemplary system 400 for integrating and connecting medical devices 402 into a medical facility network 404. The example system 400 includes a terminal 406. The terminal 406 interfaces with the medical facility network 404. A display 408 is in communication with the terminal 406 and a medical device 402 within wireless range of the medical facility network 404. The medical facility network 404 is configured to transmit an initialization signal to the medical device 402 and is configured to automatically initialize in response to receiving the initialization signal.

In the exemplary embodiment of FIG. 4, it is contemplated that the system 400 may provide access to any number of medical devices in a health care facility. A Device Services Manager (DSM) 412 and Device Services Controllers (DSCs) 414, 416 foam at least part of the system 400 for identifying and connecting a medical device 402 in a health care facility with a hospital's information system, e.g., network 404.

As part of the system 400, and acting as a publicly accessible Virtual Device Network router (VDN router), the DSM 412 manages DSCs 414, 416 units on the Local Area Network (LAN) at each location. The DSM 412 and its DS Cs 414, 416 join equipment across the Internet to create a “Virtual Device Network” (VDN) 418. Together, these components enable the VDN administrator to discover medical devices 402 located within the facility and allows an administrator to set up and manage individual Virtual IP (VIP) addresses and routes to allow access to each of the individual medical devices 416 located within a desired facility.

Thus, secure access and management of medical equipment, devices 402 and connectivity of these medical devices 402 in a network protected by a firewall from outside networks may be achieved while maintaining a hospital's information system policy along with the integrity of patient information and the customer's hospital information system network firewall.

In the illustrated embodiment of FIG. 4 the system 400 has a device server manager 412 that resides in a wide area network external to both the first and second device servers 414, 416. Both the first and second device servers 414, 416 create their own direct communication tunnel to the device manager by periodically authenticating themselves to the device manager 412 and establishing an outgoing TCP/IP stream connection to the device manager and then keeps that connection open for future bi-directional communication on the outgoing TCP/IP stream connection. The device servers 414, 416 communicate with both the medical devices 402 and the hospital information systems 404.

In some embodiments, the systems and methods described herein may allow a user and/or administrator located at a host console to open a connection to a designated port on a device server which establishes a connection through to the target medical device. This local device server can then initiate a connection to the controlling device manager which will manage the connection between the host and the medical device.

The systems and methods described herein may be used to remotely monitor and diagnose a medical device. In some examples medical devices are provided whereby the system may allow an administrator to receive an incoming connection from the medical device through which the communication may include both stream traffic (e.g. TCP/IP) and packet traffic (e.g. UDP) oriented network connections. The TCP packet header information in general identifies both the source port originally sending the data and the target destination port receiving the packet.

Additionally, it should be understood that the inventive subject matter may allow for manipulating data within the responses in a manner that provides at least a communication with a medical device which would not normally communicate with the health care facility network.

Example systems and methods described herein have been used in conjunction with a medical facility network. Such a network can include a local network or facility wide network. It will be understood, however, that the systems and methods described herein may be applied to other networked devices and systems. Further, the skilled artisan will recognize the interchangeability of various features from different embodiments. Similarly, the various features and steps discussed above, as well as other known equivalents for each such feature or step, can be mixed and matched by one of ordinary skill in this art to perform compositions or methods in accordance with the principles described herein. Although the disclosure has been provided in the context of certain embodiments and examples, it will be understood by those skilled in the art that the disclosure extends beyond the specifically described embodiments to other alternative embodiments and/or uses and obvious modifications and equivalents thereof. Accordingly, the disclosure is not intended to be limited by the specific disclosures of embodiments herein.

Various objects, features, aspects and advantages of the present invention will become more apparent from the following detailed description of preferred embodiments of the invention, along with the accompanying drawing.

What is claimed is:

1. A system for integrating and connecting medical devices into a medical facility network, comprising:
a device server/terminal interfacing with the medical facility network;
a medical device which is attached to the device server either wired or wirelessly; and
wherein the medical facility network is configured to transmit an initialization signal to the medical device and is configured to automatically initialize in response to receiving the initialization signal.

2. The system of claim 1, wherein a display is in communication with the device server to show status and other information.

3. The system of claim 1, wherein the medical device is automatically detected by the medical facility network upon introduction into the medical treatment area.

4. The system of claim 1, wherein initializing comprises of powering the medical device into an active power state.

5. The system of claim 1, wherein the medical facility network is connected to the Internet, thereby facilitating data exchange between the medical facility network and another entity.

6. The system of claim 1, wherein the wireless range is limited to approximately the medical treatment area.

7. The system of claim 1, wherein the medical facility network comprises of a local network or facility wide network.

8. The system of claim 1, wherein the system is further configured to remotely monitor and diagnose remote medical devices once the medical device has been located and analyzed by the hospital information systems.

9. The system of claim 1, further comprising a conduit manager to create a direct communication tunnel to a medical device.

10. The system of claim 1, wherein the device server/terminal comprises a first device server that resides in a first local network and a second device server that resides in a second local network distinct from the first local network.

11. The system of claim 10, further comprising a device serve that resides in a wide area network external to both the first and second device servers.

12. The system of claim 11, wherein both the first and second device servers create their own direct communication tunnel to the device manager by periodically authenticating themselves to the device manager and establishing an outgoing TCP/IP stream connection to the device manager and then keeps that connection open for future bi-directional communication on the outgoing TCP/IP stream connection and wherein the device servers communicates with both the medical devices and the medical facility network.

13. The system of claim 12, wherein the device server initiates a connection the device manager which will manage the connection between the host and the medical device.

14. The system of claim 1, further configured to target the medical device whereby the system may be notified when the targeted medical device is malfunctioning.

15. The system of claim 14, wherein the device server is further configured to provide information from the medical device to a system administrator through which error messages, device data and other information may be sent remotely to the administrator for analysis and review.

16. A method to allow for connectivity of a medical device in a health care setting comprising:
detecting and locating the medical device in the medical treatment area by the medical facility network;
identifying a medical device and authenticating the medical device and providing an administrator or privileged user access to the information received from the medical device at a remote location;
initializing the medical device; and
connecting and monitoring the medical devices.

17. The method of claim 16, further comprising of using a device server to communicate, monitor and connect the medical devices with an administrator and/or hospital information system.

18. The method of claim 16, further comprising of using an external adaptor to uniquely identify any attached equipment.

19. The method of claim 16, further comprising of automatically detecting the medical device upon introduction of the medical device into the medical treatment area.

20. The method of claim 16, further comprising of powering the medical device into an active power state to cause initialization of the device.
